(19) United States
(12) Patent Application Publication
(10) Pub. No.: US 2026/0148501 A1
(43) Pub. Date: May 28, 2026

(54) METHOD FOR PROVIDING TRANSFORMATION PARAMETERS FOR THE DEVELOPMENT OF A DYNAMIC MODELING OF A BUILDING

(71) Applicant: Robert Bosch GmbH, Stuttgart (DE)

(72) Inventors: Robert Lindemann, Grossdubrau Ot Kronfoerstchen (DE); Toni Kirscht, Dresden (DE)

(21) Appl. No.: 19/397,110

(22) Filed: Nov. 21, 2025

(30) Foreign Application Priority Data
Nov. 27, 2024 (DE) 10 2024 211 312.3

(51) Int. Cl. G06T 19/00; G06T 17/20

(52) U.S. Cl. CPC G06T 19/00; G06T 17/20

(57) ABSTRACT

A method for providing transformation parameters for the development of a dynamic modeling of a building. The method includes: providing three-dimensional models of objects in the building, wherein the three-dimensional models are each specified by the transformation parameters and by geometric features; analyzing the geometric features of the three-dimensional models in order to identify identical three-dimensional models; assigning identical three-dimensional models to individual groups based on the results of the analysis; providing the respective transformation parameters of the individual groups for the development of the dynamic modeling of the building using the respective transformation parameters of the individual groups. A computer program, a device, and a storage medium are also described.

### CROSS REFERENCE

The present application claims the benefit under 35 U.S.C. § 119 of Germany Patent Application No. DE 10 2024 211 312.3 filed on Nov. 27, 2024, which is expressly incorporated herein by reference in its entirety.

### FIELD

The present invention relates to a method for providing transformation parameters for the development of a dynamic modeling of a building. The present invention furthermore relates to a computer program, a device, and a storage medium for this purpose.

### BACKGROUND INFORMATION

Building information modeling (BIM) is an established method that enables the creation and management of digital representations of the physical and functional features of a building. The related art is characterized by the static nature of BIM models, which generally comprise defined construction and design information.

However, significant challenges arise when these static, highly detailed models are to be used for dynamic modeling or simulations. In particular, the computational complexity can be very high during the development and subsequent execution of the dynamic models based on these complex three-dimensional BIM models. There is therefore a lack of efficient and scalable solutions that allow for the seamless adaptation of static BIM models for dynamic modeling.

### SUMMARY

The present invention provides a method, a computer program, a device, and a computer-readable storage medium. Features and details of the present invention can be found in the disclosure herein. Features and details that are described in connection with the method according to the present invention of course also apply in connection with the computer program according to the present invention, the device according to the present invention, and the computer-readable storage medium according to the present invention, and vice versa in each case, so that mutual reference can also always be made with regard to the disclosure of the present invention.

The present invention provides a method for providing transformation parameters for the development of a dynamic modeling of a building. According to an example embodiment of the present invention, the method comprises:
providing three-dimensional models of objects, in particular static objects such as items like tables, chairs, signs or walls, in the building, wherein the three-dimensional models are each specified by the transformation parameters and by geometric features, wherein the transformation parameters in particular specify an arrangement of the objects in the building, and the geometric features in particular specify a structure of the objects,
analyzing the geometric features of the three-dimensional models to identify identical three-dimensional models, preferably with an adjustable tolerance range, wherein with the adjustable tolerance range, similar three-dimensional models can be identified rather than identical three-dimensional models,
assigning identical three-dimensional models to individual groups based on the results of the analysis,
providing the respective transformation parameters of the individual groups for the development of the dynamic modeling of the building using the respective transformation parameters of the individual groups; in other words, the respective transformation parameters of the individual groups are provided in particular to be used in the context of developing the dynamic modeling of the building.

The three-dimensional models are preferably building information modeling (BIM) models. The development of dynamic modeling is preferably carried out in a development environment, in particular a game development environment such as Unity. By assigning identical three-dimensional models to groups, the amount of calculating and storing within the context of the development of dynamic modeling can be significantly reduced, in particular since identical objects, or the corresponding three-dimensional models, do not always have to be instantiated individually, but can be instantiated on the basis of the group. For example, a group can correspond to a number of identical chairs, wherein the individual chairs can then be instantiated in the context of the development of the dynamic modeling using the respective transformation parameters of this group without having to instantiate each chair individually.

Advantageously, the present invention can provide that the geometric features include polygons, a mesh structure, a point count and/or a point arrangement of the three-dimensional models. The transformation parameters can comprise, for example, rotation, scaling and/or position data of the three-dimensional models. In this way, a detailed description of every object in the building can be guaranteed. This allows for precise grouping of objects with similar or identical geometric features and can therefore enable more efficient development of dynamic modeling. Defining the transformation parameters using rotation, scaling, and position data allows for flexible adaptation of the three-dimensional models to the requirements of dynamic modeling.

It is also possible that the procedure further comprises:
reducing the respective number of polygons in the three-dimensional models, especially based on an analysis of the geometry of the three-dimensional models.

This can advantageously further reduce the resulting file size of the dynamic modeling.

According to an example embodiment of the present invention, it is also advantageous if the procedure further comprises:
carrying out the development of the dynamic modeling, wherein three-dimensional models are instantiated based on the respective transformation parameters of the individual groups.

In this way, efficient and automated modeling of the building can be achieved by instantiating three-dimensional models based on the transformation parameters of the individual groups.

One possible option is that the dynamic modeling can be a virtual safety training in the building, wherein a safety scenario such as a fire alarm or a chemical accident is modeled in the context of the virtual safety training. This virtual safety training can be used to practice dealing with emergencies and to improve the safety behavior of people in the building, for example through an escape route simulation. Dynamic modeling can advantageously enable a realistic and interactive training experience. It is possible that the dynamic modeling is carried out using an augmented reality device and/or virtual reality device, and that the dynamic modeling is developed accordingly for such an application.

In a further possibility, it can be provided that the method further comprises:
identifying security gaps in the building based on the virtual security training.

For example, obstacles in an escape route, tripping hazards, or regions in the building that are too narrow could be identified and then accordingly modified.

According to an example embodiment of the present invention, optionally, it is possible that the dynamic modeling is a modeling of heat circulation in the building. This enables simulations to analyze energy efficiency and heat losses. Furthermore, users can optimize heat generation and identify potential weaknesses.

For example, it can be provided that dynamic modeling is planning of spaces of the building, i.e., how a room layout is designed or how the walls run, and the equipment, i.e., for example which work equipment or furniture is arranged where in the building. In other words, this in particular enables the use of the generated three-dimensional models, preferably BIM models, for planning rooms and their equipment within the building. This can be done by adding virtual furniture, walls, or other elements, creating a detailed simulation of the interiors. Conversely, an existing building can be remodeled and entered using an AR and/or VR device, for example, to analyze the building, for example with regard to safety requirements for the spaces and the equipment. The transformation parameters can be used to virtually place objects in specific locations and define the spatial arrangement.

Furthermore, according to an example embodiment of the present invention, it can be provided that the method further comprises:
identifying modifications to the building in order to optimize heat circulation and/or to optimize the spaces and equipment with regard to safety.

This can, for example, improve heat distribution and/or optimize the spaces and equipment with regard to safety aspects.

The present invention also relates to a computer program, in particular a computer program product, comprising commands which, when the computer program is executed by at least one computer, cause the computer to carry out the method according to the present invention. The computer program according to the present invention thus delivers the same advantages as have been described in detail with reference to a method according to the present invention.

The present invention also relates to a device for processing data that is configured to carry out the method according to the present invention. For example, at least one computer which executes the computer program according to the present invention can be provided as the device. The computer can have at least one processor for executing the computer program. A non-volatile data memory can also be provided, in which the computer program is stored and from which the computer program can be read by the processor for execution.

The present invention can also relate to a computer-readable storage medium which comprises the computer program according to the present invention and/or commands which, when executed by at least one computer, cause the computer to carry out the method according to the present invention. The storage medium is formed, for example, as a data memory such as a hard drive and/or a non-volatile memory and/or a memory card. The storage medium can be integrated into the computer, for example.

Furthermore, the method according to the present invention can also be designed as a computer-implemented method. Alternatively or additionally, at least one of the disclosed method steps can be computer-implemented and/or performed automatically.

Further advantages, features and details of the present invention can be found in the following description, in which exemplary embodiments of the present invention are described in detail with reference to the figures. The features mentioned herein can be essential to the present invention in each case, either individually or in any combination.

### BRIEF DESCRIPTION OF THE DRAWINGS

FIG. 1 is a schematic visualization of a method, a device, a storage medium and a computer program according to exemplary embodiments of the present invention.

FIG. 2 is a schematic representation of a building according to exemplary embodiments of the present invention.

### DETAILED DESCRIPTION OF EXAMPLE EMBODIMENTS

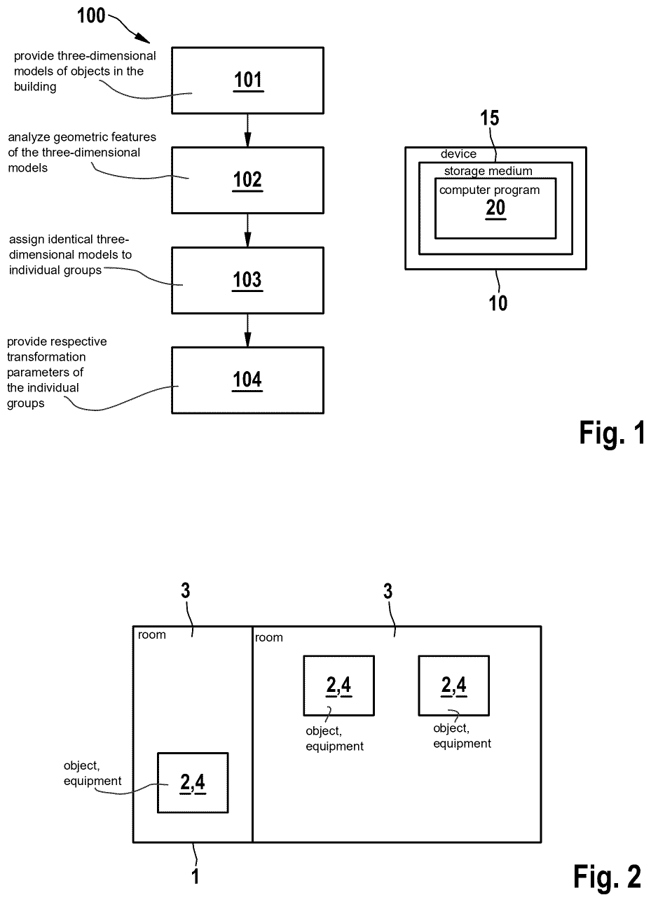

FIG. 1 schematically shows a method 100, a device 10, a storage medium 15, and a computer program 20 according to exemplary embodiments of the present invention.

FIG. 1 shows in particular an exemplary embodiment of a method 100 for providing transformation parameters for the development of a dynamic modeling of a building 1. In a first step 101, three-dimensional models of objects 2 in the building 1 are provided, wherein the three-dimensional models are each specified by the transformation parameters and by geometric features. In a second step 102, the geometric features of the three-dimensional models are analyzed in order to identify identical three-dimensional models. In a third step 103, identical three-dimensional models are assigned to individual groups based on a result of the analysis 102. In a fourth step 104, the respective transformation parameters of the individual groups are provided for the development of the dynamic modeling of the building 1 using the respective transformation parameters of the individual groups.

FIG. 2 schematically shows a building 1 according to exemplary embodiments. This comprises a plurality of spaces 3, or, in other words, rooms. In the spaces 3, there are objects 2 or equipment 4.

BIM (building information modeling) is in particular a digital method for the planning, construction and management of buildings, including three-dimensional models of all objects of the building.

By means of the present invention, three-dimensional model data, especially of BIM, can be used in an automated and data-efficient manner for the development of dynamic modeling, for example in a development environment such as Unity. This allows the area of application of the otherwise static three-dimensional model data of BIM to be expanded, in particular with dynamic application possibilities. Dynamic modeling can be used, for example, in the context of safety training in the form of a computer game. This allows, for example, safety scenarios such as fire alarms or chemical accidents, or even instructions for action, to be simulated and practiced interactively. Furthermore, it is possible to perform various simulations, such as an escape route simulation or heat circulation simulation. Additionally, the data of BIM can be regularly visualized through the automated process, which can support planning. The solution can be applied to building models, but also to any type of three-dimensional model, e.g., machines. Furthermore, applications created by means of three-dimensional models can be quickly updated when there are changing real-world conditions. Furthermore, this solution allows optimized applications to help make security training, for example, in virtual worlds like the Metaverse even more immersive, despite the typically low computing power of AR and VR devices.

According to one possibility, the three-dimensional models can preferably be automated to go through individual process steps of the workflow with the aid of two scripts. These comprise, in particular, all necessary analysis, grouping and remodeling steps that are required for seamless transfer between the different software environments. This can significantly reduce the programming and modeling effort usually required for such applications.

The three-dimensional models exported from the BIM are automatically analyzed and grouped based on their features (polygons, mesh structure, number/arrangement of points). Additionally, the rotation, scaling and position data of the identical objects can be saved, for example in a separate text file. With the aid of this information, the three-dimensional model of the respective groups only needs to be imported once in the game development environment since the individual groups are used and can then be instantiated based on the transformation parameters, i.e., in particular the rotation, scaling and position data, of the identical three-dimensional models of the same group. Additionally, the script preferably analyzes the geometry of the exported three-dimensional models and performs automated polygon reduction. The combination of these work processes can reduce the file size of the overall model by approximately 60-80%, which can enable meaningful use within the game development environment. Furthermore, the entire process is in particular automated, which means that development time can be reduced from several weeks or months to just a few days. The application resulting from the solution can be run and used on desktop PCs, tablets, phones, or AR and VR headsets.

In general, the described process therefore focuses in particular on an automated analysis of all objects in a scene (BIM export) and a grouping based on a polygon structure (preferably with an adjustable tolerance range) as well as a storage of the respective associated rotation, scaling and position data. This allows a three-dimensional model to be used as a parent object in the game development environment (e.g., Unity), and all remaining objects within the group can be instantiated based on this model and their specific position and rotation data. As a result, child objects no longer require in particular their own three-dimensional model. Furthermore, all elements can be placed identically to their position in the BIM model. The reduction of the polygon structure of the three-dimensional model (parent object) is in particular an intermediate step within the process according to exemplary embodiments of the present invention in order to increase both the performance of the process and that of the final result in the game development environment.

The above description of the embodiments describes the present invention exclusively in the context of examples. Of course, individual features of the embodiments, provided they make technical sense, can be freely combined with one another without departing from the scope of the present invention.

What is claimed is:

1. A method for providing transformation parameters for the development of a dynamic modeling of a building, the method comprising the following steps:
providing three-dimensional models of objects in the building, wherein the three-dimensional models are each specified by respective transformation parameters and by respective geometric features;
analyzing the respective geometric features of the three-dimensional models to identify identical three-dimensional models;
assigning identical ones of the three-dimensional models to individual groups based on results of the analysis; and
providing the respective transformation parameters of the three-dimensional models of the individual groups for the development of the dynamic modeling of the building using the respective transformation parameters of the individual groups.

2. The method according to claim 1, wherein: (A) the respective geometric features include: (i) polygons of the three-dimensional model, and/or (ii) a mesh structure of the three-dimensional model, and/or (iii) a point count and/or a point arrangement of the three-dimensional model, and/or (B) the respective transformation parameters include: (i) rotation data of the three-dimensional model, and/or (ii) scaling data of the three-dimensional model, and/or (iii) position data of the three-dimensional model.

3. The method according to claim 1, wherein the three-dimensional models include polygons, and wherein the method further comprises:
reducing a number of the polygons in the three-dimensional models.

4. The method according to claim 1, further comprising:
carrying out the development of the dynamic modeling, wherein the three-dimensional models are instantiated based on the respective transformation parameters of the of the three-dimensional models of the individual groups.

5. The method according to claim 4, wherein the dynamic modeling is a virtual safety training in the building, wherein a safety scenario is modeled in a context of the virtual safety training.

6. The method according to claim 5, further comprising:
identifying security gaps in the building based on the virtual security training.

7. The method according to claim 4, wherein the dynamic modeling is a modeling of heat circulation in the building.

8. The method according to claim 4, wherein the dynamic modeling is a planning of spaces and equipment of the building.

9. The method according to claim 7, further comprising:
identifying modifications to the building to optimize heat circulation.

10. The method according to claim 8, further comprising:
identifying modification to the building to optimize the spaces and equipment with regard to safety.

11. A device for processing data that is configured to carry out a method for providing transformation parameters for the development of a dynamic modeling of a building, the method comprising the following steps:
providing three-dimensional models of objects in the building, wherein the three-dimensional models are each specified by respective transformation parameters and by respective geometric features;
analyzing the respective geometric features of the three-dimensional models to identify identical three-dimensional models;
assigning identical ones of the three-dimensional models to individual groups based on results of the analysis; and
providing the respective transformation parameters of the three-dimensional models of the individual groups for the development of the dynamic modeling of the building using the respective transformation parameters of the individual groups.

12. A computer-readable storage medium on which are stored commands for providing transformation parameters for the development of a dynamic modeling of a building, the commands, when executed by at least one computer, causing the at least one computer to perform the following steps:
providing three-dimensional models of objects in the building, wherein the three-dimensional models are each specified by respective transformation parameters and by respective geometric features;
analyzing the respective geometric features of the three-dimensional models to identify identical three-dimensional models;
assigning identical ones of the three-dimensional models to individual groups based on results of the analysis; and
providing the respective transformation parameters of the three-dimensional models of the individual groups for the development of the dynamic modeling of the building using the respective transformation parameters of the individual groups.
